(19) United States
(12) Patent Application Publication
(10) Pub. No.: US 2011/0262813 A1
(43) Pub. Date: Oct. 27, 2011

(54) METHOD OF PRODUCING CURRENT COLLECTORS FOR ELECTROCHEMICAL DEVICES

(75) Inventor: Joey Chung Yen JUNG, Vancouver (CA)

(73) Assignee: EVT POWER INC., Vancouver (CA)

(21) Appl. No.: 13/046,484

(22) Filed: Mar. 11, 2011

Related U.S. Application Data
(60) Provisional application No. 61/326,519, filed on Apr. 21, 2010.

(51) Int. Cl. H01M 4/68; C25D 5/00; H01M 4/04

(52) U.S. Cl. 429/245; 29/623.5; 29/623.1; 205/158

(57) ABSTRACT

The present invention relates to a process for producing current collectors, current collectors made by such a process, and batteries containing current collectors made by such a process. The current collector is produced from a polymer substrate that is rendered electro-conductive and is electroplated at temperatures that are less than a softening temperature of the substrate. The substrate can be rendered electro-conductive by applying an electro-conductive material and/or by including a powder in the substrate, wherein the powder is carbon powder, a metal powder, or a metal-alloy powder.

Pursuant to 35 U.S.C. §119, I claim the priority benefits of U.S. provisional patent application 61/326,519 filed by Joey Chung Yen Jung on Apr. 21, 2010.

### FIELD OF INVENTION

This invention relates to current collectors for electrochemical batteries.

### BACKGROUND

Battery electrodes for conventional, commercially available lead-acid batteries have been made from pasted plates for many years. Such plates, also called “current collectors,” commonly have a support base or matrix that is a metal grid, usually a lead alloy. In order to produce the current collector the holes of the grid are filled with a battery active material such as a mixture of lead oxide and 33% dilute sulfuric acid. The term “battery active material” is often used interchangeably in the field with “paste” and “electro-active paste.” The process of applying the electro-active paste to the grid is referred to in the vernacular of the art simply as “pasting”. The terms grid, matrix, and base structure are used interchangeably herein to refer to the support structure of a current collector to which the electro-active paste is applied.

Recently attempts have been made to find non-metal substrates for current collectors that are more suitable than lead grids. The goal has been to find a sturdy, lightweight, porous substrate that retains the battery active material even in the hostile environments and operating conditions commonly found in a wide range of battery applications. For instance, Kelley et al, U.S. Pat. No. 6,979,513 (“Kelley”), describe the use of carbon foam to form a battery current collector, and Gyenge et al U.S. Pat. No. 7,060,391 (“Gyenge”) teach the use of carbon foam deposited with a layer of lead-tin alloy in the construction of a current collector for a lead acid battery.

These alternative approaches to the traditional lead grid improve the utilization efficiency and the battery energy density. However, current collectors such as those of Kelley and Gyenge have a major disadvantage in that carbon foam is fragile and lacks structural integrity, which complicates manufacturing processes such as pasting and battery assembly. In addition, whilst a carbon foam current collector is much lighter than metal-based matrices, carbon foam current collectors of the Gyenge type must be thicker than a conventional lead grid in order to maintain structural integrity and strength. Consequently, the number of such carbon foam current collectors that can be arranged in parallel and series is less than in a battery using conventional lead grids. This means that a lead acid battery employing the Gyenge type current collectors has lower power density than a conventional lead acid battery using a lead grid.

An additional drawback in carbon foam current collectors such as those of Kelley and Gyenge is that the matrix is carbonized. “Carbonization” or “carbonized” are used herein to refer to the treatment or state, respectively, of a carbonaceous material that results from exposing the material to sufficiently high temperatures in the right environment—generally anon-oxidizing environment—to convert the structure of the material entirely to carbon. (The term “non-carbonized” as used here refers to a material that has not been exposed to carbonization.) For instance, the devices of Gyenge and Kelley employ carbonized grids made under pressure, with high temperature, at long treatment times, and in an inert gas environment. In addition to producing a relatively weak grid, these process steps and requirements significantly increase the cost of manufacture. It would be advantageous to the battery industry to produce a grid that is light-weight but is non-carbonized.

It would also be advantageous to the battery industry to develop simple and light-weight current collectors that can be used as both negative and positive electrodes. US Patent Application 29269658A1 discloses a grid structure for a “negative current collector.” Similarly, Soria et al. disclose a lightweight metallized polymeric mesh structure for a “negative current collector” (“Lead-Acid Batteries with Polymer Structured Electrodes for Electric Vehicle Applications”. 1999. Journal of Power Sources. 78:220-230). Both of these references disclose greatly reduced negative electrode weight; however, since they both use conventional positive electrodes the overall capacity and the cycle life of the battery are still limited by the conventional positive electrode plates. On the other hand, Martha et al. disclose current collectors used for both “positive and negative current collectors.” A Low-Cost Lead-Acid Battery with High Specific Energy. 2006. Journal of Chemical Science. 118(1):93-98. These current collectors, which are based on an ABS rubber grid, are heavy and have a complex structure which adds to manufacturing costs.

Those skilled in the art are familiar with deficiencies of other types of current collectors. For example, metal-foil current collectors presently used in lithium ion batteries have at least two problems: 1) low volume cathode material loading limiting the battery capacity; and 2) high risk of thermal runaway due to poor electrical conductivity of the cathode material. Thermal runaway may occur when a microscopic impurity such as copper or nickel is mixed inside the cathode material, leading to a substantial electrical short and development of a sizable current between the positive and negative plates.

Harada et al in U.S. Pat. No. 6,020,089 describe three-dimensional polyurethane polymer substrate electrodes suitable for use in nickel-metal hydride batteries. The method of Harada requires excessive processing temperatures e.g. 1100° C. to 1300° C., hydrogen gas atmospheres, and long processing times e.g. 37 minutes. In contrast, U.S. Pat. No. 4,975,515 discloses that “[a] disadvantage of known polyurethanes is that even those which have otherwise satisfactory properties do not retain sufficient hardness at elevated temperatures to make them useful in applications where they would subjected to temperatures in excess of about 175° C.” It is thus very likely that the polyurethane in Harada et al. was softened and likely distorted from its original state due to prolonged exposure to excessively high temperature and long processing time. Therefore the strength of Harada's electrode would be derived entirely or mostly from the sintered metal coating and not from the polyurethane substrate that was softened by the high process temperatures.

Finally, United States patent application US 2004/0126663A1 discloses a current collector for polymer electrolyte thin film electrochemical cells having a polymer support film. Such a current collector is designed for use in lithium ion type rechargeable batteries. The current collector is designed to have a lighter weight and volume compared to conventional current collectors used in polymer electrolyte thin film electrochemical cells. However, such current collectors have a low capacity for battery active material and, consequently, they do not resolve the problem of low volume active material loading, which problem is common in the present lithium ion battery art.

### SUMMARY OF THE INVENTION

The present invention improves upon existing art in this field by providing a method of producing un-softened three-dimensional current collectors with polymer substrate grids in open cell, foam-like structures that can be used for both positive and negative electrodes. By un-softened what is meant is that the polymer substrate has not been exposed to temperatures in excess of that which promotes deformation of the polymer. The term “softening temperature” refers to the temperature at which thermal deformation of the substrate begins. With respect to cross-linked polyurethane, the softening temperature is approximately 175° C.

As noted above, the current state of the art uses high temperatures in producing current collectors thereby contributing to substrate melting during the production process, whereas the method of the present invention employs reticulated polymers coated and electroplated at temperatures below the softening temperature for the polymer.

This distinction is noteworthy because the present invention is based in part upon my surprising and fortuitous discovery that if current collectors are made of un-softened polymers, including un-softened polyurethane foam, they display an enhanced utilization efficiency of the active material; therefore, the amount of battery active material required to produce an equivalent battery capacity is reduced. This applies to current collectors used for both negative and positive electrodes. Consequently, the final weight of the battery is decreased very significantly and the overall energy density of the battery is increased compared to the prior art. Prior to this disclosure, those in the art of battery design/manufacture have been oblivious to the advantages of using process temperatures below the softening temperatures of the materials the substrates are made of.

Injection molding or plastic fiber weaving technology can produce three dimensional polymer substrates that have high surface areas and low weight at low cost. The polymer substrate can be rendered electrically conductive by electroless plating of metal or metal alloy. Alternatively, the polymer substrate can be sprayed with or immersed in an electrically conductive coating such as, by way of example, carbon, nickel, tin, or silver. I have also discovered that such lightweight three-dimensional polymer substrates can be rendered electrically conductive by addition of carbon powder, a metal powder, or metal alloy powder, and this compliments the production of current collectors at low temperatures. Finally, the electrically conductive three-dimensional polymer can be electroplated with a variety of coatings.

Most significantly, the process disclosed herein provides for these steps at a temperature below the softening temperature of the polymer, thus maintaining the strength of the polymer. Such a three-dimensional polymer substrate that has been rendered electrically conductive and electroplated, can act as both negative and positive current collectors in electrochemical devices such as batteries and fuel cells.

The advantages of the three-dimensional polymer-based electrode according to the current invention are many, and are particularly evident in terms of power density relative to, for instance, carbon foam electrodes. For a lead-based battery, the invention results in reduced battery weight, improved structural integrity, and increased energy and power densities. Whereas performance of existing carbon foam electrodes lags behind the conventional lead electrodes, the three-dimensional polymer based electrodes of the present invention offer substantially enhanced performance over both carbon foam and lead electrodes.

For a lithium ion battery, the three-dimensional polymer based electrode of the present invention improves the volume of cathode active material loading, resulting in higher battery capacity, and enhances electric contact between the current collector and cathode material, thus reducing the risk of thermal runaway. For a nickel metal hydride battery, the present invention results in decreased nickel consumption.

### BRIEF DESCRIPTION OF THE FIGURES

FIG. 1 is a flow chart showing one embodiment of the method of the invention.

FIG. 2 is a side view of a current collector produced according to the method of the invention.

FIG. 3 is a perspective drawing of a battery comprising current collectors produced according to the method of the invention.

### DETAILED DESCRIPTION OF THE INVENTION

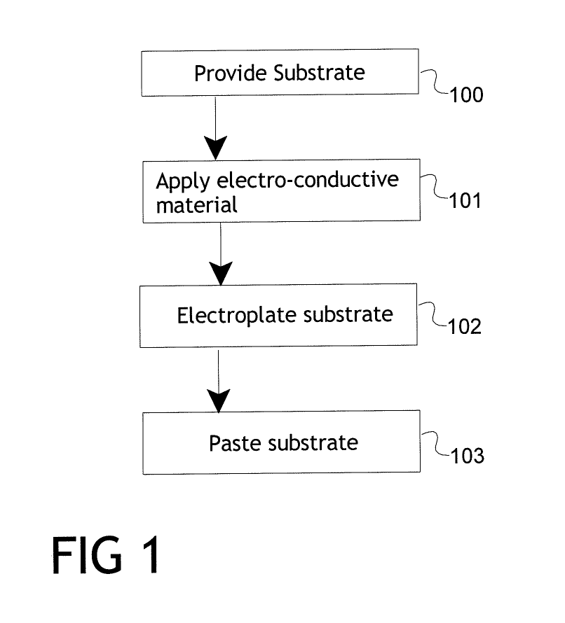

FIG. 1 illustrates the basic process disclosed herein for producing a polymer substrate current collector without thermal deformation of the substrate.

A non-carbonized polymer substrate is provided at step 100. Reticulated polyurethane foam (“RPUF”) is preferred. Cross-linked RPUF, also referred to as “furan plastic,” is particularly preferred. The advantage of cross linked RPUF is that it has a higher softening temperature than un-cross-linked RPUF. Given that one of the novel and advantageous features of the present invention is processing the substrate at a temperature below its softening temperature, increasing the softening temperature is a significant benefit.

The substrate is rendered electro-conductive 101. This step may be carried out using a number of techniques. For instance, I have discovered that including at least one of carbon powder, metal powder, and metal-alloy powder in the substrate renders the substrate electro-conductive. Also, well known techniques such as electroless plating and conductive spraying may be used to apply an electro-conductive material such as, for example, carbon, a metal, or a metal-alloy. Silver and nickel are preferred. Optionally, a metal or metal-alloy coat can be deposited on the electro-conductive material.

The substrate is then electroplated 102. The electroplating solution and the material that is electroplated are dependent upon the nature of the substrate and what electro-conductive material was applied at step 101. For instance, if silver was applied, then the electroplating may be done with, for instance, lead, a lead-tin alloy, or a lead-tin-silver alloy. If nickel was used at step 101, then the electro-plating may be done with, for instance, nickel.

All of the steps of the process thus far are performed at a temperature that is below the softening temperature of the substrate and preferably at between about 15° C. to about 25° C. For instance, if the substrate is RPUF, the process temperature of these steps is kept below 175° C. The advantage of such low processing temperatures is, as disclosed above, that avoiding softening or melting of the substrate enhances the utilization efficiency of the battery active material, and thereby reduces the amount of battery active material required to acquire an equivalent battery capacity.

At step 103 at least a portion of the grid or substrate is pasted. This step may not be required depending on the material used for the substrate and the type of current collector being made.

A tap, also referred to in the art as a “tab” or “lug,” and/or a frame may be attached to the current collector by means well known in the art. Depending on the materials being used and the type of current collector being produced the tap and/or frame attachment may occur at virtually any point in the process. One can even provide a substrate at step 100 that already has a tap and/or frame incorporated or attached, in which case a separate attachment step, per se, is not required.

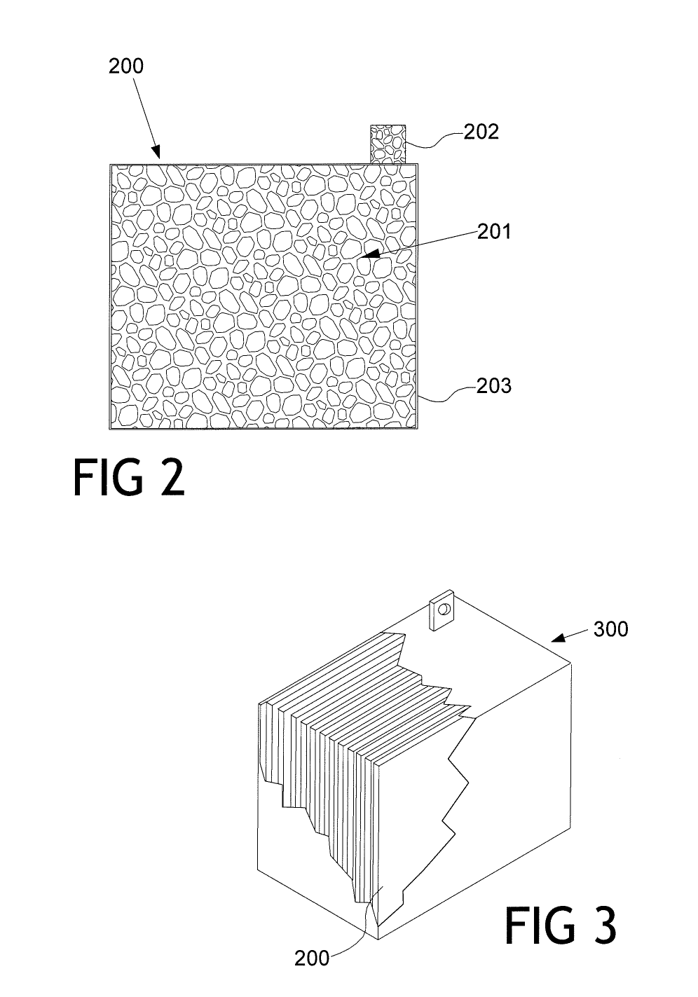

At the completion of this process one has produced a 3-D current collector, and example of which is represented by FIG. 2. The current collector 200 comprises a non-carbonized substrate 201 that was rendered electro-conductive and electroplated at temperatures less than the softening temperature of the substrate. The current collector has a tap 202. It may also have a frame 203.

FIG. 3 illustrates how a plurality of such current collectors 200 can be finished and assembled into a battery 300.

the following examples provide sufficient details to allow one of skill to practice the invention and to illustrate my preferred embodiments.

### Example 1a

### Production of Current Collectors with a Lead Coating For Lead Acid Batteries

Current collectors for lead acid batteries are produced by the process of the invention as follows:

A 7″×4′×10′ RPUF block with 20 pores per inch (ppi) is cut into multiple sheets 6″×8″×0.2″. One of the cut RPUF sheets is immersed into a mixture of 5% by weight p-toluene sulfonic acid and 95% by weight furfuryl alcohol for 30 seconds at room temperature, for instance about 15° C. to about 25° C.

The RPUF sheet is then dried, for instance by placing it inside a fume hood and/or passing the sheet through a wringer. The dried sheet is then cut to smaller sheets, for instance 5.35″×2.60″.

The cut sheets are compressed. This may be done by sandwiching them between two Teflon® coated graphite plates. The sheets are compressed to 0.08″. The compressed sheets are placed in a 200° C. oven for 10 minutes to allow the RPUF polymer to cross link into furan plastic.

The resulting reticulated furan plastic sheets are converted to silver coated plates by spraying them with a thin conductive silver coating. This can be done using an air spray gun with an air compressor set at 45 psi. This step takes place at a temperature below the softening temperature of the furan plastic. Two passes of sprays are applied on each side, whereby a total of 0.5 g coating is deposited to allow complete coating coverage. When spraying, the air spray gun is held 45 cm away from the sheets. An example of the silver coating material is a mixture of 50% by volume MG Chemicals 8420-900 mL and 50% by volume MG Chemicals 435-1L.

A top lead frame and a lead tap are cast onto the silver coated plate.

A lead coating is electroplated onto the silver coated plate at a temperature below the softening temperature of the furan plastic substrate and, preferably, at about 15° C. to about 25° C.

When a positive current collector is required, a preferred electroplating thickness is approximately 300 μm obtained by positive plate electroplating for 150 minutes at 5 amperes per plate. When a negative current collector is required, the preferred thickness is approximately 100 μm with negative plate electroplating for 50 minutes at 5 amperes per plate. The lead electroplating bath consists of the following components: 58.4 volume % of 50 weight % lead tetrafluoroborate, 4 volume % of 54 weight % tetrafluoroboric acid, 27 g/L boric acid, 1 g/L gelatin, 37.6 volume % water.

This technique is used to produce both positive and negative current collectors for lead acid batteries. Negative current collectors produced with this method have a 40% weight reduction compared to a conventional lead grid negative current collector. Positive current collectors produced with this method have a 10% weight reduction compared to a conventional lead grid positive current collector.

The positive current collector is pasted with conventional lead acid battery positive active material. The negative current collector is pasted with negative active material. Approximately 55 g of positive active material is pasted onto the positive plates and 35 g of negative active material is pasted onto the negative plates. The positive battery active material contains 75.8 weight % lead oxide (PbO), 6.8 weight % 1.4 g/cm³ sulfuric acid, 13.4 weight % water, 3.8 weight % Pb₃O₄, and 0.2 weight % graphite powder. The negative battery active material contains 80.1 weight % lead oxide (PbO), 6.7 weight % of 1.4 g/cm³ sulfuric acid, 11.7 weight % water, 0.6 weight % BaSO₄, 0.2 weight % carbon black, 0.1 weight % sodium lignosulfonate, and 0.5 weight % humic acid.

As noted above, an unexpected result of preparing the current collectors at a temperature below the softening temperature of the substrate is that the positive and negative electrodes have higher utilization efficiency of the battery active material and less battery active material is thus required. For example, a lead acid battery employing conventional positive current collectors requires 15.8 g of positive battery active material per amp-hour, of capacity. In contrast a lead acid battery employing the electrodes manufactured according to the above process requires only 11.2 g of positive battery active material per amp-hour of capacity.

### Example 1b

### Production of Current Collectors with Lead Tin Alloy Coatings For Lead Acid Batteries

Current collectors for lead acid batteries in this example are prepared in identical fashion to Example 1a above with the exception that the electroplating solution is modified so that lead-tin alloy instead of lead can be used to electroplate a coating on the surface of the current collector substrate. As above, electroplating is carried out at a temperature below the softening temperature of the furan plastic and, preferably, at about 1.5° C. to about 25° C.

The thickness for the positive current collector of this example is approximately 300 μm with electroplating for 150 minutes at 5 amperes per plate. The thickness for the negative current collector is approximately 100 μm with electroplating for 50 minutes at 5 amperes per plate.

The lead-tin electroplating bath consists of the following components: 51 volume % of 50 weight % lead tetrafluoroborate, 7.4 volume % of 50 weight % tin tetrafluoroborate, 4 volume % of 54 weight % tetrafluoroboric acid, 27 g/L boric acid, 1 g/L gelatin, and 37.6 volume % water.

### Example 1c

### Production of Current Collectors with Lead Silver Alloy Coatings For Lead Acid Batteries

The current collectors for use in lead acid batteries in this example are produced in identical fashion to Example 1a above with the exception that the electroplating solution is modified so that lead-silver alloy can be used to electroplate a coating on the surface of the current collector substrate. Electroplating is carried out at a temperature below the softening temperature of the substrate, preferably at about 15° C. to about 25° C. The thickness for the positive current collector is approximately 300 μm with electroplating for 150 minutes at 5 amperes per plate. The thickness for the negative current collector is approximately 100 μm with electroplating for 50 minutes at 5 amperes per plate.

The lead-silver electroplating bath consisted of the following components: 55.4 volume % of 50 weight % lead tetrafluoroborate, 3 volume % of 50 weight % silver tetrafluoroborate, 4 volume % of 54 weight % tetrafluoroboric acid, 27 g/L boric acid, 1 g/L gelatin, and 37.6 volume % water.

### Example 1d

### Production of Electrodes with a Lead Tin Silver Alloy Coating For Lead Acid Batteries

The current collectors in this example are prepared in identical fashion to Example 1a above except that the electroplating solution is modified so that lead-tin-silver alloy can be used to electroplate a coating on the surface of the current collector substrate instead of lead. Electroplating is carried out at a temperature below the softening temperature of the substrate and, preferably, at about 15° C. to about 25° C. The thickness for the positive current collector is approximately 300 μm with electroplating for 150 minutes at 5 amperes per plate. The thickness for the negative current collector is approximately 100 μm with electroplating for 50 minutes at 5 amperes per plate.

The lead-silver electroplating bath consists of the following components: 51 volume % of 50 weight % lead tetrafluoroborate, 4.4 volume % of 50 weight % tin tetrafluoroborate, 3 volume % of 50 weight % silver tetrafluoroborate, 4 volume % of 54 weight % tetrafluoroboric acid, 27 g/L boric acid, 1 g/L gelatin, and 37.6 volume % water.

### Example 2

### Production of Current Collectors with a Nickel Coating For Nickel Metal Hydride Batteries

Current collectors with a nickel coating for nickel metal hydride batteries are produced according to the invention as follows: A 7″×4′×10′ RPUF block with 60 ppi is cut into multiple sheets 6″×8″×0.2″. One of the cut RPUF sheets is immersed into a mixture of 5% by weight p-toluene sulfonic acid and 95% by weight furfuryl alcohol for 30 seconds at about 15° C. to about 25° C.

The RPUF sheet is then dried, for instance by placing inside a fume hood and/or passing the sheet through a wringer. The dried sheet is then cut to smaller sheets, for instance 5.35″×2.60″.

The cut sheets are sandwiched between two Teflon® coated graphite plates. The sheets are compressed to 0.08″ and placed in a 200° C. oven for 10 minutes to allow RPUF cross-linking into furan plastic.

The reticulated furan plastic sheets are sprayed with a thin conductive nickel coating by an aerosol based nickel conductive spray can. Two passes of sprays are applied on each side of each sheet to deposit a total of 0.6 g coating to allow complete coating coverage. When spraying, the spray can is held 45 cm away from the sheets.

A top copper frame and a copper tap are soldered onto the nickel coated plate.

Additional nickel is electroplated onto the nickel coated plate at 55° C. The extra thickness of the nickel coating for the positive current collector is approximately 250 μm with the positive plate plating for 120 minutes at 5 amperes per plate. The thickness for the negative current collector is approximately 100 μm with the negative plate plating for 50 minutes at 5 amperes per plate.

The nickel electroplating bath consists of the following components: 300 g/L nickel sulfate, 50 g/L nickel chloride, 40 g/L boric acid, and 1 g/L gelatin.

The electroplated plate produced by this method can be used as a current collector for a nickel metal hydride battery. The above method produces both positive and negative current collectors for nickel metal hydride batteries. A negative current collector produced by this method has a 50% reduction in weight compared to a conventional nickel grid negative current collector. A positive current collector produced by this method has a 15% reduction in weight compared to a conventional nickel grid positive current collector.

### Example 3

### Production of Current Collectors with a Nickel Coating for Lithium Ion Batteries

Current collectors for positive electrodes of Li ion batteries are produced according to the invention as follows: A 7″×4′×10′ RPUF block with 100 ppi is cut into multiple sheets in the size of 6″×8″×0.1″. One of the cut RPUF sheets is immersed into a mixture of 5% by weight P-toluene sulfonic acid and 95% by weight furfuryl alcohol for 30 seconds at about 15° C. to about 25° C.

The RPUF sheet is then dried, for instance by placing inside a fume hood and/or passing the sheet through a wringer. The dried sheet is then cut to smaller sheets, for instance 5.35″×2.60″.

The cut sheets are sandwiched between two Teflon coated graphite plates and compressed to 0.08″. The compressed sheets are placed in a 200° C. oven for 10 minutes to allow RPUF cross linking into furan plastic.

The reticulated, furan plastic sheets are sprayed with a thin conductive nickel coating with an aerosol spray can. Two passes of sprays are applied on each side to deposit a total of 0.6 g coating to allow complete coating coverage. When spraying, the spray can was held 45 cm away from the sheets.

A top copper frame and a copper tap are soldered onto the nickel coated plate.

Additional nickel is electroplated onto the nickel coated plate at 55° C. The extra thickness of the nickel coating for the positive current collector is approximately 150 μm with the positive plate plating for 75 minutes at 5 amperes per plate. The thickness for the negative current collector is approximately 50 μm with the negative plate plating for 25 minutes at 5 amperes per plate. The nickel electroplating bath consists of the following components: 300 g/L nickel sulfate, 50 g/L nickel chloride, 40 g/L boric acid, 1 g/L gelatin.

This method produces current collectors for positive (cathode) electrodes for lithium ion batteries.

### SUMMARY

The invention can be at least partially summarized by means of the following enumerated statements.

Statement 1. The invention includes a process for producing a current collector. The process comprises the steps of: (a) providing a non-carbonized polymer substrate; (b) rendering the substrate electro conductive; and, (c) electroplating the substrate, wherein Steps (b) and (c) are performed at temperatures that are less than a softening temperature of the substrate.

Statement 2. The invention further includes a process according to Statement 1 wherein Step (b) comprises applying an electro-conductive material to the substrate.

Statement 3. The invention further includes a process according to Statement 2 wherein the electro-conductive material applied is at least one of carbon, a metal, and a metal alloy.

Statement 4. The invention further includes a process according to Statement 2 wherein the applying is performed by at least one of electroless plating and conductive spraying.

Statement 5. The invention further includes a process according to Statement 1 wherein Step (b) comprises the step of including in the substrate at least one of: carbon powder, a metal powder, a metal-alloy powder.

Statement 6. The invention further includes a process according to Statement 1 further comprising the step of attaching a tap to the substrate.

Statement 7. The invention further includes a process according to Statement 1 wherein the temperatures of Steps (b) and (c) are between about 15° C. to about 25° C.

Statement 8. The invention further includes a process according to Statement 1 further comprising the step of pasting at least a portion the substrate with a battery active material.

Statement 9. The invention further includes a process according to Statement 1 wherein the substrate provided at Step (a) is reticulated polyurethane foam (RPUF).

Statement 10. The invention further includes a process according to Statement 9 wherein the RPFU is cross-linked.

Statement 11. The invention further includes a process according to Statement 9 further comprising the step of immersing the RPUF in a mixture of P-toluene sulfonic acid and furfuryl alcohol.

Statement 12. The invention further includes a process according to Statement 1 wherein Step (c) comprises electroplating lead or a lead-containing substance to the substrate.

Statement 13. The invention further includes a process according to Statement 12 wherein the lead-containing substance is chosen from the group consisting of: a lead-sliver alloy, a lead-tin-silver alloy, and a lead-tin-silver alloy.

Statement 14. The invention further includes a process according to Statement 1 wherein Step (c) comprises electroplating nickel to the substrate.

Statement 15. The invention further includes a current collector produced according to the process of Statement 1.

Statement 16. The invention further includes a battery comprising at least one current collector produced according to the process of Statement 1.

Statement 17. The invention further includes a process for producing a current collector, the process comprising the steps of: (a) providing a non-carbonized polymer substrate wherein the polymer substrate has a softening temperature, and wherein the polymer substrate has been rendered electro-conductive by the inclusion of at least one of carbon powder, a metal powder, and a metal-alloy powder; and, (b) electroplating the substrate.

Statement 18. The invention further includes a process according to Statement 17 wherein Step (b) is performed at a process temperature less than the softening temperature of the substrate.

Statement 19. The invention further includes a current collector produced according to the process of Statement 17.

Statement 20. The invention further includes a battery comprising at least one current collector produced according to the process of Statement 17.

1-20. (canceled)

21. A process for producing a current collector, said process comprising the steps of:
(a) providing a non-carbonized polymer substrate, wherein the polymer substrate has a softening temperature;
(b) rendering the substrate electro-conductive, wherein said rendering is done at a temperature not in excess of the softening temperature;
(c) electroplating the substrate, wherein said electroplating is done at a temperature not in excess of the softening temperature; and,
(d) pasting the substrate with battery active material, wherein said pasting is done at a temperature not in excess of the softening temperature,
whereby the current collector is produced without exposing the substrate to temperatures in excess of the softening temperature.

22. A process according to claim 21 wherein Step (b) comprises applying an electro-conductive material to the substrate.

23. A process according to claim 22 wherein the electro conductive material is at least one member chosen from the group consisting of: carbon, a metal, and a metal alloy.

24. A process according to claim 22 wherein said applying is performed by at least one of electroless plating and conductive spraying.

25. A process according to claim 21 wherein Step (b) comprises the step of including in the substrate at least one member chosen from the group consisting of carbon powder, metal powder, and metal-alloy powder.

26. A process according to claim 21 further comprising the step of attaching a tap to the substrate.

27. A process according to claim 21 wherein the temperatures of Steps (b)-(d) are between about 15° C. to about 25° C.

28. A process according to claim 21 wherein the substrate provided at Step (a) is reticulated polyurethane foam (RPUF).

29. A process according to claim 28 wherein the RPUF is cross-linked.

30. A process according to claim 28 further comprising the step of immersing the RPUF in a mixture of P-toluene sulfonic acid and furfuryl alcohol.

31. A process according to claim 21 wherein the electroplating of Step (c) is carried out by electroplating lead or a lead-containing substance to the substrate.

32. A process according to claim 21 wherein the electroplating of Step (c) is carried out by electroplating a lead-containing substance chosen from the group consisting of: a lead-sliver alloy, a lead-tin alloy, and a lead-tin-silver alloy.

33. A process according to claim 21 wherein the electroplating of Step (c) is carried out by electroplating nickel or a nickel-containing alloy to the substrate.

34. A current collector produced according to the process of claim 21.

35. A battery comprising at least one current collector produced according to the process of claim 21.

36. A process for producing a current collector, said process comprising the steps of:
(a) providing a non-carbonized polymer substrate wherein the polymer substrate has a softening temperature, and wherein the polymer substrate has been rendered electro-conductive by the inclusion of at least one of a carbon powder, a metal powder, and a metal-alloy powder;
(b) electroplating the polymer substrate; and,
(c) pasting the polymer substrate with a battery active material.

37. A process according to claim 36 wherein Step (b) and Step (c) are carried out at temperatures less than the softening temperature of the substrate, whereby the current collector is produced without exposing the substrate to temperatures in excess of the softening temperature.

38. A current collector produced according to the process of claim 36.

39. A battery comprising at least one current collector produced according to the process of claim 36.
